(19) United States
(12) Patent Application Publication
(10) Pub. No.: US 2006/0190104 A1
(43) Pub. Date: Aug. 24, 2006

(54) Methods and apparatus for mountable culinary recipe storage and display

(76) Inventors: Matthew Ray Little, Marietta, GA (US); Bobby Kinling Chau, Kennesaw, GA (US)

Correspondence Address: Matthew Ray Little, 2112 Clearwater Drive SE, Marietta, GA, 30067, US

(21) Appl. No.: 11/360,743

(22) Filed: Feb. 23, 2006

Related U.S. Application Data
(60) Provisional application No. 60/655,714, filed on Feb. 23, 2005.

(51) Int. Cl. G05B 15/00

(52) U.S. Cl. 700/83

(57) ABSTRACT

An electronic device which may used to enter, display, store, and/or retrieve culinary recipes with ease such as through touchscreen capabilities and that may be implemented in a mountable, flip-down, and/or turn on a pivot or otherwise positional device.

### CROSS-REFERENCE RELATED APPLICATIONS

This is a continuation-in-part of the U.S. patent application Serial. No. 60/655,714 filed Feb. 23, 2005.

### BACKGROUND OF INVENTION

The invention relates to an electronic touchscreen recipe database management device particularly mounted on a wall or underneath a kitchen cabinet and enables the embodiment to be positioned in such a way to the user's preference. Moreover, the invention relates to the system and method for retrieving and displaying the desired culinary recipes in a retractable, out-of-the-way format

Typically, culinary recipes are stored in a conventional way within books, magazines, or recipe cards. In today's digital world where we are moving towards a paperless environment, the problems of using computers for storing and displaying culinary information can pose the same problems as the conventional methods previously stated. These problems consist of but are not limited to the hazards caused by the possibility of fire from hot stove tops, spills from mixing, or any of the other dangers associated with the kitchen, including the ill clutter of countertops. With the invention stated herein, all are issues are eliminated by providing a single point of reference to culinary information in an off-the-counter, mountable device leaving the counter top free from clutter and away from the dangers of food preparation and cooking.

### BRIEF SUMMARY OF INVENTION

An electronic device which may be used to enter, display, store, and/or retrieve culinary recipes with ease such as through touchscreen capabilities and that may be implemented in a mountable, flip-down, and/or turn on a pivot or otherwise positional device.

Referring to the use of the invention with culinary subject matter, among the problems solved by the exemplary embodiment are the problems posed by the use of conventional recipes/cookbooks. Commonly, with use of recipes/cookbooks in the kitchen, counter space may become cluttered, and such clutter may interfere with or slow down the cooking process. It may be difficult finding an ingredient or even the recipe or cookbook if the counter is cluttered with the elements involved in the cooking process as well as other elements that may not be directly related to the process. Also, in using a recipe or cookbook while cooking makes it susceptible to kitchen hazards (i.e. fire from stovetop, accidental spill, etc). For example, a recipe may become spattered with grease or other substance, or a cookbook may be moved or disturbed so that the page with the recipe is lost or damaged.

The use of the invention with respect to culinary subject matter solves other problems encountered in the use of conventional recipes and/or cookbooks. An exemplary embodiment may be used as a source for recipes that may be taken from one or more original sources. For example, a chef may use the exemplary embodiment to find a recipe from a cooking magazine, another recipe from televised cooking show, and yet another recipe from a website, or other original sources. The original source may be the chef's own cache of recipes that would previously have been written down on note cards or other material. A chef does not have to juggle different recipe books, recipe note cards, pages from a cooking magazine, or printouts from electronic sources for recipes.

### BRIEF DESCRIPTION OF VIEWS OF DRAWINGS

FIG. 1 is a block diagram of the computer components.

FIG. 2 illustrates the base of the embodiment comprising of the computer components and the flip down mechanism.

FIG. 3 illustrates the front view of the embodiment in an open or flip down position.

FIG. 4 illustrates the side view of the embodiment in an open or flip down position.

FIG. 5 illustrates a flowchart of the process and program that displays various menus for navigating through the touchscreen interface to retrieve from the recipe database.

FIG. 6 depicts the invention in use.

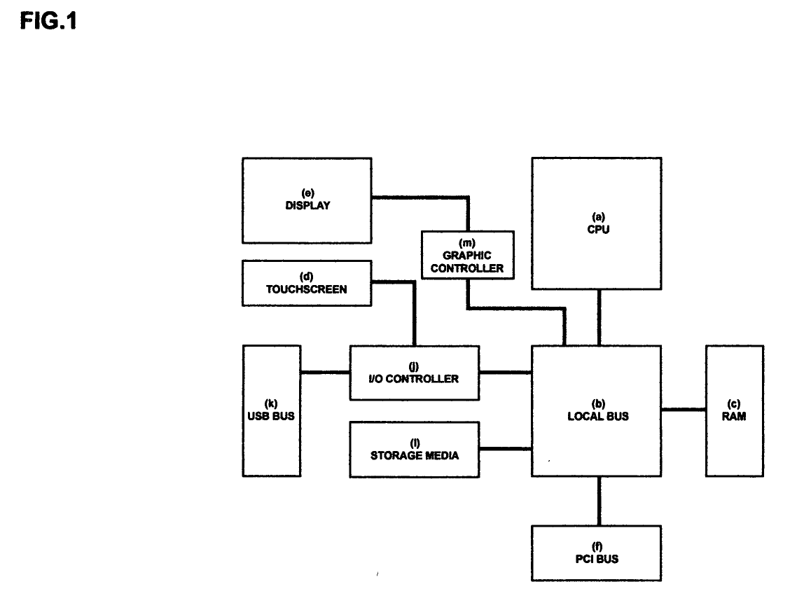

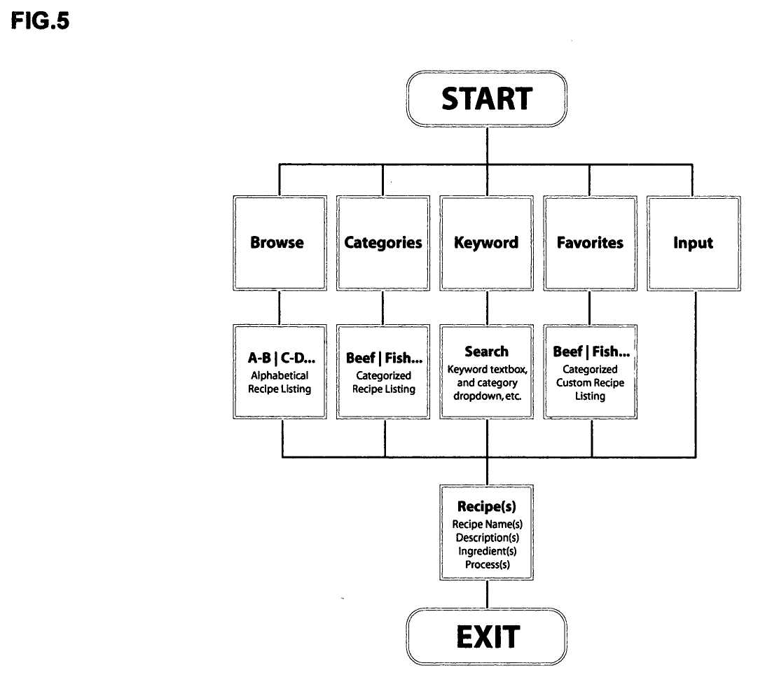

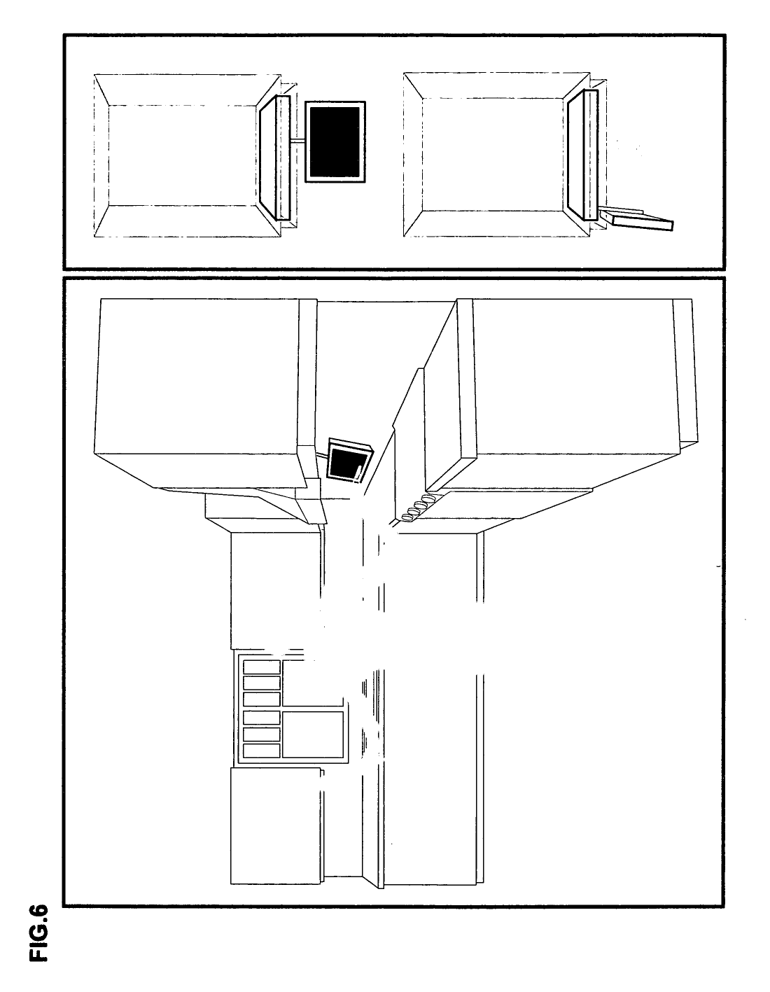

A block diagram of a computer system as depicted in FIG. 1 includes a central processing unit (CPU) a which is connected to common local bus b. The processor is responsible for processing instructions of a computer's programs such as the operating system and/or other specialized applications which are retrieved from the system's random access memory (RAM) c. When a user touches the display e, an internal the touchscreen controller d will send instructions to the CPU a which executes the operation of the software application as depicted in FIG. 5.

The local bus b linked together with the peripheral component interconnect (PCI) bus f provides communications to various components such as, but not limited to an Ethernet adapter, modem, audio adaptor, and/or the graphics controller m. In addition, the input/output (I/O) controller j, attached to the local bus b, connects to the universal serial bus (USB) bus k for external peripherals such as a keyboard, mouse, and/or printer. Also, connecting to the I/O controller j is the Touchscreen controller d acquiring input instructions by the operator.

The operating system and the recipe database application as depicted in FIG. 5. would be stored onto a storage media 1 such as compact flash, microdrive, or IDE drive.

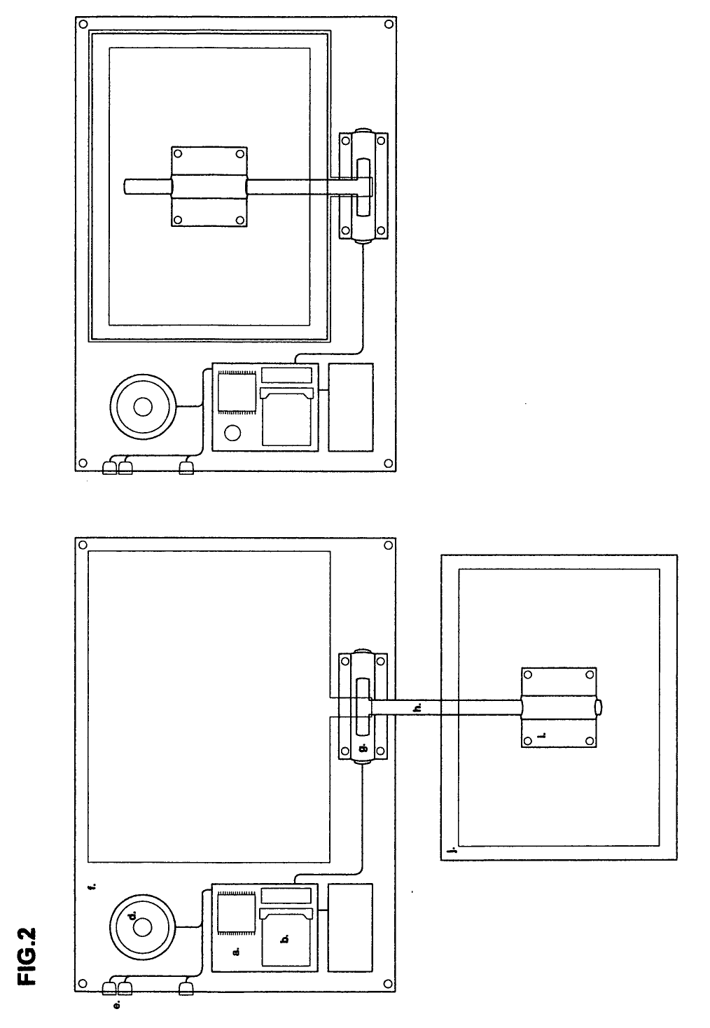

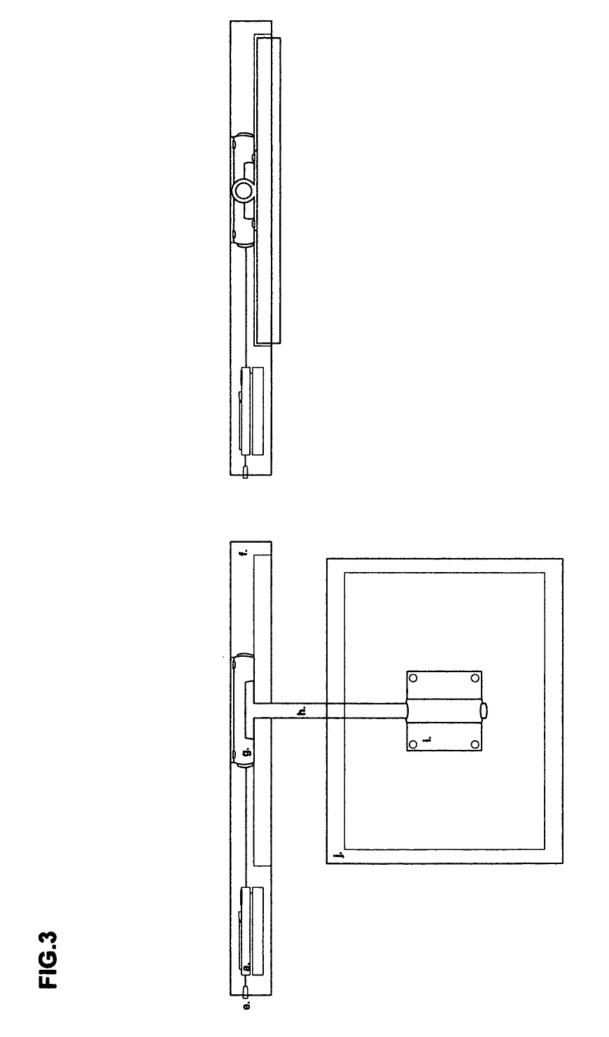

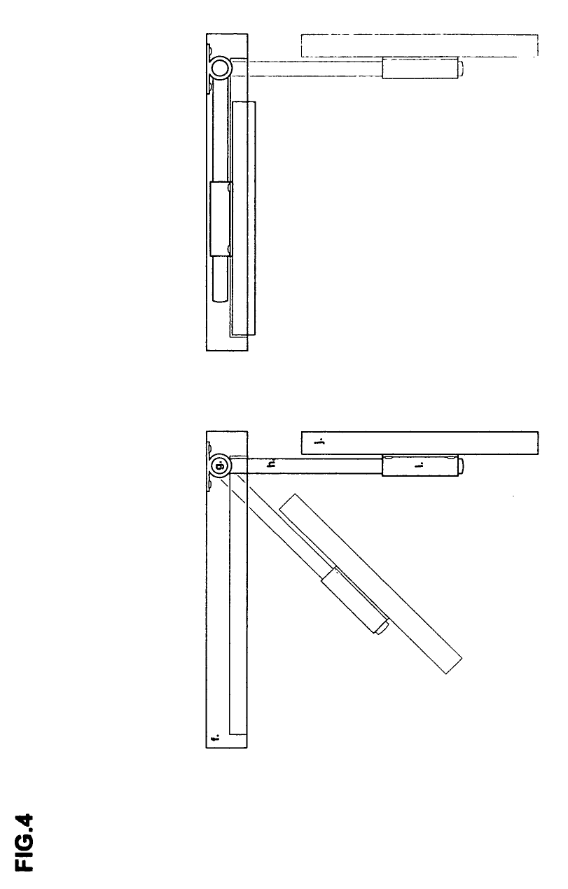

The housing f of the embodiment as depicted in FIG. 2-FIG. 4 is comprised of system components as described from FIG. 1. The flip down mechanism g mounted onto the housing f, allows the display j to vertically be flipped down (connect via rod h) during use and flipped up when stowed away. A fixed to back of the display j is a swivel/pivot mechanism i which allows the display j to rotated horizontally for optimal viewing.

### DETAILED DESCRIPTION OF INVENTION

The invention relates to an electronic device which may be used to enter, display, store, and/or retrieve culinary recipes with ease such as through touchscreen capabilities and that may be implemented in a mountable, flip-down, and/or turn on a pivot or otherwise positional device.

The invention relates to the ability to enter, store, display and/or retrieve recipes in a tidy, orderly, and simplistic fashion and that may be done so without necessarily taking up much space such as generally consumed by conventional recipe books, or other information sources or references.

Generally stated, the invention includes apparatuses and methods that provide a housing with elements for the entry, storage, display, and retrieval of culinary recipes. The housing may be specifically configured to suit a specific environment in a kitchen such as under the cupboard/cabinets or other place where the invention may be used. Specifically, the housing may be configured to be readily positionable with respect to its environment so that a user may easily enter, store, view, organize and/or retrieve information. An embodiment of the invention contemplates the user may be using the embodiment in an environment where the user is generally standing versus other positions the user may assume. But the invention may be configured to be usable by a user assuming a sitting position, and/or any other position. Whether standing and/or sitting in the environment including the embodiment, the user may conveniently use the embodiment to enter and/or to store information, to view the information, to organize the information, to retrieve the recipes or other information, and to take other actions with respect to the information.

Advantageously, the exemplary embodiment and in particular, the housing of the exemplary embodiment is not fixed in a specific location or position. The housing may be moved for ease of use by the user. Conveniently, the user may adjust the exemplary embodiment so the information may be entered, stored, viewed, and/or retrieved more easily depending upon the user's position or position to be assumed. For example, the display on the housing of the exemplary embodiment may be positioned by pivoting the housing left or right As another example, the housing may be moved up or down in a vertical direction to adapt to the height of the user or other circumstances such as the user changing from a standing to a sitting position. In the exemplary embodiment, the housing is generally rectangular, but may be of any other shape.

The exemplary embodiment includes a housing with a display that has various functions. The display, as its name implies, may display information. In addition, the display may have or may be connected to elements that allow for the entry of information and acknowledgement of the entry of such information. For example, the display may include “touchscreen” capabilities so a user may enter information, may select from a variety of options, may be presented with information, may retrieve information, etc. by simply “touching” the appropriate area on the display. As another example (or in addition), the display may be connected to a keypad, keyboard, mouse or other device to enter or retrieve such information, for the selection among presented options, etc. The display may take on any shape and size, but in the exemplary embodiment, the shape and size of the display may be configured relative to the shape and size of the housing. Thus, a rectangular housing may typically have a rectangular display, the display taking up most of the “face” of the housing.

The housing also may include an attachment panel and/or other such element that facilitate(s) the attachment of the housing to an appropriate place in the environment in which the embodiment of the inventions is to be used. The attachment panel may be positioned with respect to the display in the housing such that the attachment panel serves its function and with the display serving its function. The display and the attachment panel may be joined by a hinge, or other device or element that allows the display to be positioned for use of the embodiment such that the display may be positioned separately from the attachment panel or otherwise. The hinge-type device may allow for the display to be moved with respect to the attachment panel, and/or moved so that the display may fit adjacent to or otherwise with respect to the attachment panel when the display is not in use. In other words, the housing may have a “closed position” whereby the display may be moved so that it fits closely with respect to the attachment panel, and an “open position” whereby the display may be positioned so that it may be easily viewed and moved for easier viewing with respect to the attachment panel. For example, assume the attachment panel is fitted underneath a typical cupboard in a kitchen. When “closed”, the display of the exemplary embodiment may be configured so that it is parallel to the attachment panel. When “open”, the display may be configured so that it has a position of 90 degrees with respect to the attachment panel (or other position).

As noted above, the exemplary embodiment may provide a feature or features that allows or allow the display to be “pivoted” to allow for easier use/viewing. A first embodiment may allow for the entire housing to be pivoted so that the user may view the display in any of a variety of positions. Another embodiment may allow for just display to be pivoted.

Further, the exemplary embodiment provides for content with respect to its display of information. The content that may be displayed may vary and may be obtained from various sources. For example, the embodiment may be provided with a storage device such as an electronic (or otherwise) memory that is programmed or otherwise includes information such as recipes, etc. The exemplary embodiment may be made to accept information on electronic media, recorded devices, over the internet or other information source, etc. The information that is displayed may be displayed from memory, may be displayed “live”, or otherwise. For example the exemplary embodiment may display culinary recipes (by way of disk, flash drive, internet, e-mail, etc.) such as recipes from a particular chef, television program, etc.

Advantageously, the invention, and in particular, the exemplary embodiment allows for the content received from various sources to be filtered, entered, organized, edited, deleted, etc. per the instructions of the user or otherwise.

An exemplary embodiment of the invention is presented herein by reference to an apparatus and/or a method of using same where the information that may be displayed, stored, and/or retrieved relates to culinary information such as recipes, cooking tips, measurements, exchanges, timers, and the like.

1. An electronic mountable flip-down apparatus comprising of a touchscreen display for navigating through recipe data that is stored internally; system components are designed to store, retrieve, edit, and manage said data within the embodiment.

2. The electronic apparatus as set forth in claim 1 can be typically mounted underneath a kitchen cabinet or onto a kitchen wall discretely or otherwise hidden position with the ability to flip-down to open the touchscreen interface.

3. The discrete and/or hidden position as stated in claim 2 has the ability, once flipped down, to turn on a pivot in multiple viewable positions.

4. The electronic apparatus as set forth in claim 1 will be equipped with touchscreen capabilities allowing the viewer(s) to navigate through the menus and access the internally stored recipe data.

5. The electronic apparatus as set forth in claim 1 has the ability to access the internet via ethernet port and/or wi-fi connectivity.

6. The system components as set forth in claim 1 has the ability to store, retrieve, edit, and manage recipe data through the use of either software keyboard and/or input ports such as serial, PS/2, microphone, and/or but not limited to USB ports with an external keyboard and/or mouse.

7. The menus, thru the use of the touchscreen interface, as set forth in claim 4 has the ability to access an internally stored database(s) from a categorized, searchable, and/or sortable catalog of recipes. The variety of menus available to access the recipe data consisting of but are not confined to predefined recipes, viewer's favorites, serving size, ingredients, nutritional information, cook/preparation instructions and time, cook timer. Also offering complementing beverage suggestions to selected recipes.

8. An electronic mountable flip-down apparatus as stated in claim 1 is comprised of a touchscreen monitor to display retrieved data, fold-down/pivot mechanism allowing a variety of viewable positions, a storage media to house the recipe database, I/O ports for peripherals allowing the ability to store, retrieve, edit, and manage internal recipe data, and central processing unit (CPU) to handle requests and service the appropriate information back to the touchscreen monitor.
